(19) United States
(12) Patent Application Publication
(10) Pub. No.: US 2026/0210488 A1
(43) Pub. Date: Jul. 23, 2026

(54) FOLDABLE HANGING DEVICE FOR PEG BOARD

(71) Applicant: Destiny Jones, Tullahoma, TN (US)

(72) Inventor: Destiny Jones, Tullahoma, TN (US)

(21) Appl. No.: 19/443,720

(22) Filed: Jan. 8, 2026

Related U.S. Application Data
(60) Provisional application No. 63/746,945, filed on Jan. 18, 2025.

(51) Int. Cl. F16M 13/02

(52) U.S. Cl. CPC F16M 13/02

(57) ABSTRACT

A foldable hanging device for a peg board, including an attachment plate to attach to the peg board, a hinge portion disposed at an end portion of the attachment plate, a movable plate connected at a first end portion thereof to the hinge portion, such that the hinge portions allows the movable plate to move hingedly with respect to the attachment portion, a hook attachment portion disposed and coupled to a bottom surface of the moveable plate, such that the hook attachment portion is disposed to be parallel to the moveable plate, a hook stabilizing portion to protrude diagonally downward from a center portion of the hook attachment portion, and a hook protruding portion to protrude from the center portion of the hook attachment portion to be parallel with respect to the moveable plate and to extend beyond a second end portion of the movable plate.

### CROSS-REFERENCE TO RELATED APPLICATIONS

This application claims priority under 35 USC § 120 from U.S. Provisional Application No. 63/746,945, entitled “Foldable Hanging Device For Peg Board,” which was filed on Jan. 18, 2025, in the United States Patent and Trademark Office, the disclosure of which is incorporated herein in its entirety by reference.

### BACKGROUND

### 1. Field

The present general inventive concept relates generally to a hanging device, and particularly, to a foldable hanging device for a peg board.

### 2. Description of the Related Art

Traditional pegboard hooks are used for varied display needs and often require items to be constantly moved on and off as a means of supply control, creating a tedious task.

In addition to this, these accessories occupy space even when not in use, which can limit available surface area for displaying or storing other items, especially in high-traffic or dynamic environments.

Therefore, there is a need for a device that facilitates and enhances the use of a pegboard.

### SUMMARY

The present general inventive concept provides a foldable hanging device for a peg board.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a foldable hanging device for a peg board, including an attachment plate to attach to the peg board, a hinge portion disposed at an end portion of the attachment plate, a movable plate connected at a first end portion thereof to the hinge portion, such that the hinge portions allows the movable plate to move hingedly with respect to the attachment portion, a hook attachment portion disposed and coupled to a bottom surface of the moveable plate, such that the hook attachment portion is disposed to be parallel to the moveable plate, a hook stabilizing portion to protrude diagonally downward from a center portion of the hook attachment portion, and a hook protruding portion to protrude from the center portion of the hook attachment portion to be parallel with respect to the moveable plate and to extend beyond a second end portion of the movable plate.

When the moveable plate is disposed in a position 90 degrees with respect to the attachment plate, an end portion of the hook stabilizing portion may contact a front portion of the attachment plate, thereby preventing the moveable plate from moving downward to an angle less than 90 degrees with respect to the attachment plate.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a foldable hanging device for a peg board attached to a peg board, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Pegboard 10
Pegboard First Panel 11
Pegboard Second Panel 12
Pegboard Hinge 13
Pegboard Holes 14
Foldable Hanging Device for a Pegboard 100
Attachment Plate 110
Movable Plate 120
Hinge Portion 130
Attachment Pegs 140
Hook Attachment Portion 150
Hook Stabilizing Portion 160
Hook Protruding Portion 170
Hook End Portion 180
Clasp Assembly 200
Clasp Assembly Ring 210
Clasp Assembly Chain 220
Clasp Assembly Spring Clasp 230
Bolt 300
Nut 400

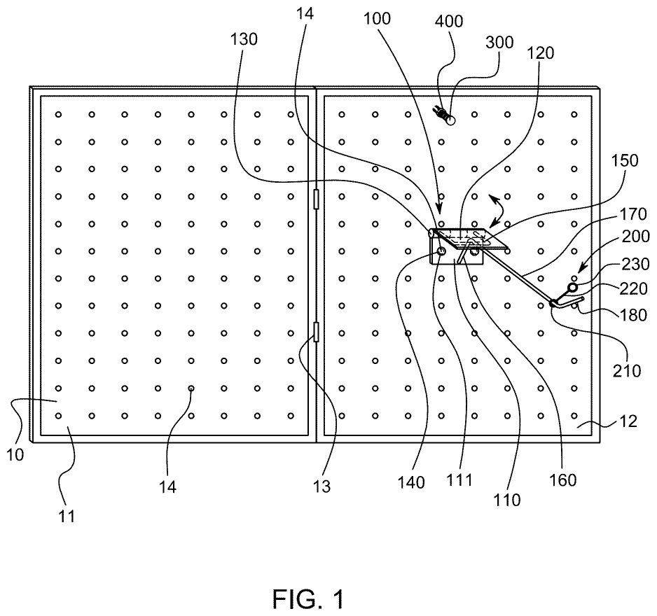

FIG. 1 illustrates a foldable hanging device for a pegboard 100 attached to a pegboard 10, according to an exemplary embodiment of the present general inventive concept.

The foldable hanging device for a pegboard 100, and all components therein, may be constructed from at least one of plastic, paper, wood, fiberglass, metal, silicone, liquid, fibers, threads, fishing line, fabric, foam, sponge, feathers, circuitry, glass, and rubber, etc., but is not limited thereto, and can be constructed from any material known to one of ordinary skill in the art.

It is important to note that although descriptions of the components below may include examples described to be in “plurality” (or “singularly”), all of the components included on or within the foldable hanging device for a pegboard 100 may be provided singularly or in plurality, based on a user's and/or a manufacturer's preference.

The pegboard 10 may be any type of pegboard known to one of ordinary skill in the art capable of attaching the foldable hanging device for a peg board 100 thereto, and may include a pegboard first panel 11, a pegboard second panel 12, a pegboard hinge 13 to hingedly attach the pegboard first panel 11 to the pegboard second panel 12, and a plurality of pegboard holes 14 on and within surfaces of the pegboard first panel 11 and the pegboard second panel 12 to receive pegs therein.

Referring to FIG. 1, the foldable hanging device for a peg board 100 may include an attachment plate 110, a movable plate 120, a hinge portion 130, a plurality of attachment pegs 140, a hook attachment portion 150, a hook stabilizing portion 160, a hook protruding portion 170, and a hook end portion 180, but is not limited thereto.

The attachment plate 110 may include a plurality of peg holes 111 that may each receive one of the plurality of attachment pegs 140 therein.

As such, the attachment plate 110 may be a portion of the foldable hanging device for a peg board 100 that may be attached to the pegboard 10, and may be attachable thereto by inserting plurality of attachment pegs 140 into the plurality of peg holes 111, such that the plurality of peg holes 111 are lined up to correspond to the plurality of pegboard holes 14 of the pegboard 10, such that the plurality of pegboard holes 14 of the pegboard 10 receive the plurality of attachment pegs 140 therein after insertion through the plurality of peg holes 111 of the attachment plate 110.

The moveable plate 120 may be hingedly (e.g., foldably) attached to the attachment plate 110 via the hinge portion 130, such that the moveable plate 120 may swing up and down in from a position of 180 degrees with respect to the attachment plate 110 to a position of 90 degrees with respect to the attachment plate 110.

The hook attachment portion 150 may be disposed and coupled to a bottom surface of the moveable plate 120, such that the hook attachment portion 150 is disposed to be substantially parallel to the moveable plate 120.

The hook stabilizing portion 160 may protrude diagonally downward from a substantially center portion of the hook attachment portion 150, such that when the moveable plate 120 is disposed in a position 90 degrees with respect to the attachment plate 110, an end portion (e.g., tip) of the hook stabilizing portion 160 may contact a front portion of the attachment plate 110, thereby preventing the moveable plate 120 from moving downward to an angle less than 90 degrees with respect to the attachment plate 110.

The hook protruding portion 170 may protrude from a substantially center portion of the hook attachment portion 150 to be parallel with respect to the moveable plate 120.

The hook end portion 180 may be disposed at an end portion of the hook protruding portion 170, and may be configured to curve upward to form a hooklike member to allow items to be attached thereto.

The present general inventive concept may also include a clasp assembly 200, a bolt 300, and a nut 400, but is not limited thereto.

The bolt 300 may be attached and secured, via the nut 400, to one of the plurality of pegboard holes 14 of one of the pegboard first panel 11 and/or the pegboard second panel 12, preferably in close proximity to a location where the foldable hanging device for a peg board 100 is attached.

The clasp assembly 200 may include a clasp assembly ring 210 attached to a first end of a clasp assembly chain 220, and a clasp assembly spring clasp 230 attached to a second end of the clasp assembly chain 220.

Thus, if the clasp assembly ring 210 is attached to the bolt 300, the moveable plate 120 may be held in a position 180 degrees with respect to the attachment plate 110 by placing the clasp assembly spring clasp 230 around a portion of the hook end portion 180.

A main purpose of the present general inventive concept is to provide efficient and secure inventory management. Ingenious and practical, the present general inventive concept introduces a complimentary accessory option that streamlines inventory handling by reducing the need for constant item removal and replacement. It promotes efficiency and organization on any standard pegboard, making it an ideal solution for businesses and environments where maintaining inventory visibility and accessibility are priorities. Designed to fold upwards, when not in use, the present general inventive concept maximizes space and minimizes interference with other activities around the pegboard, a feature that is especially beneficial in environments where space optimization is crucial, such as retail stores, workshops, or storage facilities. Once folded, the peg is held in place by a chain clasp ensuring it remains upright and stable. This not only facilitates easy portability but also prevents items from accidentally slipping off the peg; thus, maintaining organization, preventing potential damage or loss of inventory and protecting a business'bottom-line. The inclusion of a spring hinge adds further functionality by providing tension and resistance which helps to secure the peg in its upright position, enhancing stability and ensuring that items stay securely in place during utilization. Moreover, the present general inventive concept promotes ease of handling and portability. When folded and clasped, it becomes compact and easy to transport or store, facilitating convenient reorganization or relocation of inventory as needed. This portability is particularly advantageous in settings where flexibility and adaptability are key, such as retail displays or mobile storage units where the visual appeal of a defined workspace or retail environment intends to be inviting and focused on a customer-friendly atmosphere. As a result, the present general inventive concept may prove successful in the craft/novelty industry.

The present general inventive concept stands out with its innovative design that combines space-saving efficiency, secure holding mechanisms including a chain clasp and spring hinge for stability, and portability, allowing it to fold compactly for easy transport. It addresses common challenges in inventory management by maximizing pegboard space when not in use, securely holding items to prevent slippage, and facilitating quick reconfiguration or relocation as needed. The present general inventive concept's unique solution enhances organizational efficiency by maintaining a tidy workspace while offering a product with versatility and durability that can be tailored to various settings, from retail displays to workshops, ensuring practicality alongside aesthetic appeal.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A foldable hanging device for a peg board, wherein the peg board includes a plurality of pegboard holes, the foldable hanging device for the peg board comprising:
an attachment plate to attach to the peg board;
a hinge portion disposed at an end portion of the attachment plate;
a movable plate connected at a first end portion thereof to the hinge portion, such that the hinge portions allows the movable plate to move hingedly with respect to the attachment portion;
a hook attachment portion disposed and coupled to a bottom surface of the moveable plate, such that the hook attachment portion is disposed to be parallel to the moveable plate;
a hook stabilizing portion to protrude diagonally downward from a center portion of the hook attachment portion; and
a hook protruding portion to protrude from the center portion of the hook attachment portion to be parallel with respect to the moveable plate and to extend beyond a second end portion of the movable plate.

2. The foldable hanging device for a peg board of claim 1, wherein when the moveable plate is disposed in a position 90 degrees with respect to the attachment plate, an end portion of the hook stabilizing portion may contact a front portion of the attachment plate, thereby preventing the moveable plate from moving downward to an angle less than 90 degrees with respect to the attachment plate.
